(19) United States
(12) Patent Application Publication
(10) Pub. No.: US 2003/0073798 A1
(43) Pub. Date: Apr. 17, 2003

(54) Method for preparing hydroxyalkyl starch

(75) Inventors: Adrian P. Kightlinger, Muscatine, IA (US); Richard L. Antrim, Solon, IA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Grain Processing Corporation, Muscatine, IA

(21) Appl. No.: 10/167,766

(22) Filed: Jun. 12, 2002

Related U.S. Application Data
(63) Continuation of application No. 09/429,462, filed on Oct. 28, 1999, now abandoned.
Application No. 09/429,462 is a continuation of application No. PCT/US99/14100, filed on Jun. 23, 1999.
(60) Provisional application No. 60/090,313, filed on Jun. 23, 1998.

(51) Int. Cl. C08B 31/08; C08B 33/04; C08B 35/04

(52) U.S. Cl. 527/200; 536/111

(57) ABSTRACT

Disclosed is a method for preparing a hydroxyalkyl starch. In accordance with the disclosed invention, the method comprises reacting the starch with a starch hydroxylating agent in the presence of an alcohol and an alcohol-soluble alkali metal, at a temperature effective to provide a cold water soluble starch, preferably at a temperature of between about 90° and about 110° C. The starch thus produced will be granular and cold water soluble.

### RELATED APPLICATION

This application claims priority to prior U.S. Provisional Application Serial No. 60/090,313, the entire contents of which are hereby incorporated by reference in their entireties.

### TECHNICAL FIELD OF THE INVENTION

The present invention relates to a method for preparing hydroxyalkyl starches.

### BACKGROUND OF THE INVENTION

Hydroxyalkyl starches suitable for use in many commercial applications are known. Such starches typically are used in connection with well drilling fluids, textile printing pastes, adhesives, laundry finishes, food coatings, food viscosifiers, and other food products, and other applications.

Methods for preparing hydroxyalkyl starches also are known in the art. For example, as disclosed in U.S. Pat. No. 2,845,417, issued to Paul C. Kesler et al., a hydroxyalkyl starch may be prepared by reacting starch with a starch hydroxyalkylating agent in the presence of an alcohol and an alcohol-soluble alkali metal. The teachings of this patent are somewhat unsatisfactory, inasmuch as a long reaction time is required to accomplish the hydroxyalkylation reaction. As is further disclosed in U.S. Pat. No. 4,452,978, issued to James Eastman, hydroxyalkylation of granular starch in a confined zone at high temperatures, i.e., temperatures well over 100° C., is said to provide a granular hydroxyalkyl starch having a reduced pasting temperature. The starches of each of the foregoing references go through a pasting stage as they are heated above room temperature, thus limiting their commercial applicability where water solubility is desired, for example, in certain film forming applications.

It is a general object of the invention to provide a method for preparing a hydroxyalkyl starch quickly and economically. A further general object of the invention is to prepare a granular, cold water soluble hydroxyalkyl starch that does not go through a pasting stage as an aqueous mixture of the starch is heated above room temperature.

### SUMMARY OF THE INVENTION

It has been discovered that a hydroxyalkyl starch can be prepared in a hydroxyalkylation reaction under heretofore undiscovered reaction conditions, specifically, a moderate temperature and pressure. The reaction times for the hydroxyalkylation reaction under the conditions of the present inventive method are relatively short, and thus a hydroxyalkyl starch may be readily and economically prepared. Surprisingly, the starch thus prepared will be cold water soluble, and will not go through a pasting stage as an aqueous suspension is heated to or maintained at a temperature above that at which the starch loses its granular structure.

In accordance with a preferred embodiment of the invention, the method comprises reacting a starch with a starch hydroxyalkylating agent in the presence of an alcohol and an alcohol-soluble alkali metal at a temperature effective to produce a substantially non-gelatinized starch that has a degree of substitution effective to render the starch cold water soluble. The reaction temperature preferably ranges from about 90°-110° C.

In accordance with a highly preferred embodiment of the invention, the hydroxyalkylated starch is crosslinked. The starch may be crosslinked after hydroxyalkylation, or may be crosslinked during the hydroxyalkylation reaction.

### BRIEF DESCRIPTION OF THE DRAWINGS

FIG. 1 is a graphic representation of the variance with time of the viscosity (RVU) of hydroxypropylated corn starch mixtures at various levels of hydroxypropylation.

FIG. 2 is a graphic representation of the variance with time of viscosity (RVU) of an uncrosslinked hydroxypropyl starch at under 9% hydroxypropyl add on level, and of hydroxypropyl starch that has been crosslinked with phosphorus oxychloride.

FIG. 3 is a graphical representation of the variance with time of the viscosity (RVU) of an uncrosslinked hydroxypropyl starch and of hydroxypropyl starch that has been cross-linked during the hydroxypropylation reaction with epichlorohydrin.

### DESCRIPTION OF THE INVENTION

The present invention finds utility in connection with the hydroxyalkylation of starches. It is contemplated that a wide variety of starches may be considered useful in connection with the present invention. Examples include starches derived from any suitable seed or grain, and thus starches derived from such species as corn, wheat, potato, tapioca, and the like are useful in connection with the present invention. Dent corn starch is a particularly preferred starch. The starch may be provided in native form, or may be modified, such as by dextrinization, acid modification, enzymatic modification, mechanical shear, or a combination thereof.

In accordance with the invention, the starch is hydroxyalkylated with a suitable hydroxyalkylating agent. Any hydroxyalkylating agent capable of derivatizing a starch to provide a hydroxyalkyl starch may be considered useful in connection with the present invention. Preferably, the hydroxyalkylating agent is an alkylene oxide. Alkylene oxides include those compounds which contain the ethylene oxide structure, as illustrated by the skeleton formula as follows:

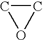

Included in the foregoing are compounds such as propylene oxide, ethylene oxide, and butylene oxide, with propylene oxide and ethylene oxide being preferred.

Many of the steps in the method of the invention may be generally conventional, and the method thus preferably includes the steps of providing the starch material and reacting it with a hydroxyalkylating agent as indicated hereinabove, the starch and hydroxyalkylating agent being present in amounts suitable for providing a hydroxyalkylated starch, with the minimum level of hydroxyalkylating agent preferably being at least about 20% by dry basis weight of the starch. As is provided in the aforementioned U.S. Pat. No. 2,845,417, the starch and hydroxyalkylating agent may be placed into contact in a slurry that comprises the starch and agent in alcohol in the presence of an alcohol-soluble alkali, and optionally further in the presence of water, the ingredients being present in amounts suitable to achieve hydroxyalkylation of the starch. Alcohol suitable for use in connection with the present invention generally include lower alkyl alcohols, such as methanol and ethanol. Suitable alcohol-soluble alkalis include agents such as sodium and potassium hydroxide.

The slurry in which the reaction is conducted preferably comprises starch and alcohol, with the starch being present in an amount ranging from about 50% to about 100% by weight of the alcohol (percentage calculated on the dry basis of starch). The alkali preferably is present in an amount ranging from about 2.9% to about 6% by weight of the starch, and preferably about 3.5% to about 5% by weight. Water preferably is present in an amount ranging from about 7% to about 40% by weight of the starch, most preferably about 25% to about 30% based on starch, with the proviso that the water:alcohol ratio preferably ranges from about 0.15:1 to about 0.22:1, with a water:alcohol ratio of 0.18:1 being preferred. The hydroxyalkylating agent preferably is added to the slurry in an amount of at least about 20%, and preferably ranging from about 20% to about 30%, by weight of the starch. A gelation inhibitor such as NaCl or Na₂SO₄ may be employed in an amount sufficient to inhibit gelation of the slurry, and may typically be present in an amount ranging from about 3% to about 20% by weight based on water. All of the foregoing ingredients may be present in any other amounts, so long as the amount of ingredient is effective to accomplish hydroxyalkylation of the starch. Other ingredients, such as crosslinkers, may be employed in suitable amounts, as set forth in more detail below.

In accordance with the invention, the reaction is performed at a temperature suitable to provide a cold water soluble starch. To achieve a cold water soluble starch, the reaction preferably is conducted at moderate temperatures, i.e., temperatures ranging from about 90° to about 110° C., and preferably, about 90° to about 100° C., and most preferably, about 95° to about 100° C. Other reaction temperatures may also be found suitable for use in conjunction with the invention. The reaction pressure preferably ranges from about 25 to about 50 psi, and is most preferably about 40 psi. When the reaction temperature and pressure are thus chosen, the reaction time is short relative to reaction time described in U.S. Pat. No. 2,845,417. The reaction time in accordance with the present invention typically is at least 1.5 hours, and preferably ranges from about 1.5 to about 2 hours.

The reaction should proceed to a level of hydroxyalkylation effective to render the starch cold water soluble. The level of hydroxyalkylation may be characterized by the molar substitution (MS) of the starch, which is a measure of the average number of moles of monomeric units per mole of anhydroglucose unit (see Rutenberg et al., “Starch Derivatives: Production and Uses,” in Whistler et al., ed., Starch: Chemistry and Technology, 2d ed. 1984, at 313). The hydroxyalkyl starch prepared by the method of the invention typically will have an MS greater than about 0.30, preferably ranging from about 0.30 to about 0.70, and more preferably about 0.4 to 0.50. Expressed alternatively in terms of percentage hydroxyalkylation, another standard calculation, the starch preferably is substituted to a level of hydroxyalkyl substitution of about 10% or greater, preferably of about 10% to about 20%, more preferably of about 10% to about 16%. For many applications, the lowest percent hydroxyalkylation effective to render the starch cold water soluble is preferred.

The resultant hydroxyalkylated starch preferably will be granular in nature, i.e., non-gelatinized or substantially non-gelatinized, and will be cold water soluble. By “cold water soluble” is contemplated that 1% by weight of the hydroxyalkyl starch in cold water (10° C.) will be soluble, and the solution will be free or essentially free of intact starch granules. In addition, the starch will be a non-pasting starch, i.e., the starch does not paste above room temperature. By this is contemplated that as an aqueous suspension of the starch in granular form is heated to or maintained at a temperature above room temperature (25° C.) and above that at which the starch begins to lose its granular structure, the starch does not go through a pasting stage, i.e., a stage wherein the starch granules swell thereby converting the granular starch to pasted starch.

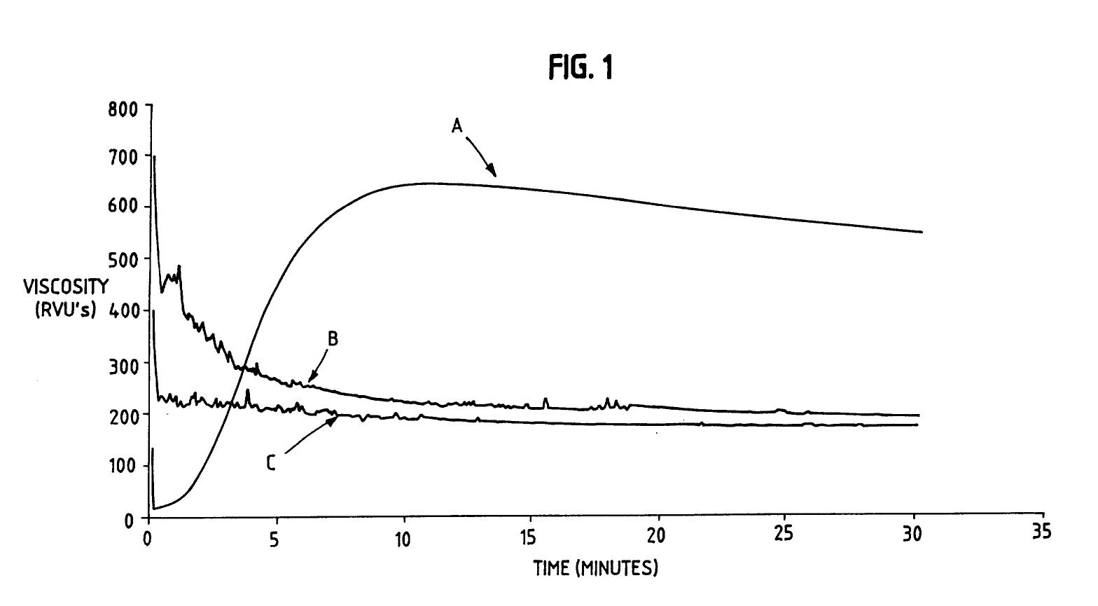

The pasting of a starch suspension or solution can be determined via viscometric analysis, such as with a Rapid Viscoanalyzer (RVA)™, model RVA-4, available from Newport Scientific, Warriewood, New South Wales, Australia. FIG. 1 illustrates an isothermal viscosity curve of three hydroxypropyl starches and water over time (each curve measures the viscosity of a 25% solids mixture at pH 6.0 at 25° C.). As shown, an 8% hydroxypropylated starch (curve A) becomes highly viscous with the passage of time and rapidly increases to a peak at about ten minutes. This curve is characteristic of starch gelatinization or pasting, and indicates that the starch granules have swelled. At a hydroxypropylation of about 10% (curve B), the starch granules become soluble. The starch does not paste, but instead dissolves without going through a pasting stage, as is evident from the absence of the characteristic pasting curve. At hydroxypropylation levels greater than about 10%, the starch will not paste, as is evident from the 14% hydroxypropylation viscosity curve (curve C).

The invention further contemplates a method for preparing a crosslinked starch. The method may include the step of providing a hydroxyalkylated starch prepared in conjunction with the foregoing teachings, and crosslinking the starch with a poly-functional crosslinking agent. Alternatively, the method of the invention may include the step of crosslinking the starch during the hydroxypropylation reaction. In either embodiment, chlorite ion, preferably in the form of sodium chlorite, optionally is used as a bleaching agent.

The crosslinking agent may be any suitable poly-functional crosslinking agent, such as epichlorohydrin, phosphorous oxychloride, acrolein, sodium trimetaphosphate and the like. The crosslinking agent may be employed in any amount and under any reaction conditions suitable for effectuating crosslinking of the starch, but preferably is used in an amount below that at which the starch becomes too crosslinked to be cold water soluble. Preferably, the crosslinking agent is employed in an amount ranging from about 0.005% to about 0.5% by weight of the starch, the amount depending on the crosslinking agent selected. When phosphorus oxychloride or epichlorohydrin is chosen, the crosslinking agent preferably is used in an amount ranging from about 0.005% to about 0.1% by dry basis weight of the starch. If sodium trimetaphosphate is used, it is preferably used in an amount ranging from about 0.01% to about 0.5% by dry basis weight of the starch. The crosslinked hydroxypropyl starches will be cold water soluble in contrast to conventional crosslinked hydroxyalkylated starches, such as those disclosed in U.S. Pat. No. 4,281,111 (Hunt et al.).

The following examples illustrate the present invention, but should not be construed as limiting in scope.

### EXAMPLE 1

This example illustrates the preparation of a high MS hydroxypropyl starch product conducted in a pressure reactor.

To a one-gallon pressure reactor equipped with an agitator, pressure relief valve and a thermometer were added, with agitation, 1795 g ethanol (EtOH, 100%), 1215 g (1100 g dry basis) pearl corn starch, 160 g H₂O, 110 g 50% NaOH solution and 16.5 g NaCl. After stirring for 5 minutes, 275 g propylene oxide was added over 7 minutes. The contents of the reactor were heated to about 100° C. and held at this temperature for two hours. At the end of the two-hour hold, the reaction mixture was cooled to room temperature, during which time the pH was adjusted to 5.9 with 300 mL of glacial acetic acid. The product was filtered on a Buchner funnel and washed with 4 liters of methanol. The filter cake was crumbled and dried overnight at room temperature. Assay of the product showed that it had a hydroxypropyl substitution (HP) of 15.96% with a reaction efficiency of 63.9% and an MS of 0.519. The product was cold water soluble, as evidenced by examination of a 1.0% aqueous solution (prepared by stirring 1 g of product, dry basis, in deionized water for 5 minutes) under a microscope that showed the solution to be essentially free of intact starch granules.

### EXAMPLES 2-8

The following examples were prepared in accordance with the process as set forth in Example 1 with parameter variations as noted.

| | | | | | Rx Conditions | | | | | | |
|---|---|---|---|---|---|---|---|---|---|---|---|
| Sample ID | Starch %⁽¹⁾ | Startch: H₂O | Alcohol | NaOH (%)⁽³⁾ | Time, hr. | Temp, ° C. | PO (%)⁽³⁾ | NaCl (%)⁽²⁾ | HP (%) ⁽³⁾ | Rx Eff (%) | MS |
| Example 2 | 53.1 | 1:0.30 | EtOH | 4.0 | 2 | 100 | 25 | 20 | 16.25 | 65.0 | 0.530 |
| Example 3 | 53.1 | 1:0.25 | EtOH | 5.0 | 2 | 100 | 25 | 20 | 16.15 | 64.6 | 0.526 |
| Example 4 | 53.1 | 1:0.25 | EtOH | 5.0 | 2 | 100 | 25 | 20 | 15.50 | 62.0 | 0.501 |
| Example 5 | 50.5 | 1:0.35 | EtOH | 5.0 | 2 | 100 | 25 | 20 | 17.19 | 68.8 | 0.567 |
| Example 6 | 43.6 | 1:0.40 | EtOH | 5.0 | 2 | 100 | 25 | 20 | 15.57 | 62.3 | 0.504 |
| Example 7 | 50.5 | 1:0.35 | EtOH | 4.0 | 2 | 100 | 25 | 10 | 15.55 | 62.2 | 0.503 |
| Example 8 | 42.7 | 1:0.40 | EtOH | 5.0 | 2 | 100 | 25 | 5 | 15.12 | 60.5 | 0.487 |

⁽¹⁾% starch = starch/(EtOH + H₂O).
⁽²⁾% on H₂O.
⁽³⁾% on starch dry basis

Results from the examples shown in this Table show that the starch/water ratio, catalyst (NaOH) level and gelation inhibitor (NaCl) level all may be varied while still obtaining good reaction efficiencies.

### EXAMPLES 9-11

The following examples were prepared in accordance with the process as set forth in Example 1 with the exception that various acid thinned corn starches were used in place of the pearl corn starch as noted.

(Thin-Boiling High MS HP-Starches)

| | | | | | Rx Conditions | | | | | | |
|---|---|---|---|---|---|---|---|---|---|---|---|
| Sample ID | Starch %⁽¹⁾ | Starch: H₂O | Alcohol | NaOH (%)⁽⁶⁾ | Time, hr. | Temp, ° C. | PO (%)⁽⁶⁾ | NaCl (%)⁽²⁾ | HP (%)⁽⁶⁾ | Rx Eff (%) | MS |
| Example | 51.8 | 1:0.30 | EtOH | 5.0 | 2 | 100 | 25 | 5 | 14.62 | 58.5 | 0.468 |
| 9³ | | | | | | | | | | | |
| Example | 51.8 | 1:0.30 | EtOH | 5.0 | 2 | 100 | 25 | 5 | 16.82 | 67.3 | 0.553 |
| 10⁴ | | | | | | | | | | | |
| Example | 45.6 | 1:0.30 | EtOH | 5.0 | 2 | 100 | 30 | 20 | 17.83 | 59.4 | 0.593 |
| 11⁵ | | | | | | | | | | | |

⁽¹⁾% starch = starch/(EtOH + H₂O)
⁽²⁾% on H₂O
⁽³⁾Base starch - B890 (available from Grain Processing Corporation, Muscatine, IA)
⁽⁴⁾Base starch - C165 (available from Grain Processing Corporation, Muscatine, IA)
⁽⁵⁾Base starch - C130 (available from Grain Processing Corporation, Muscatine, IA)
⁽⁶⁾% on starch dry basis

As shown in the above examples, acid thinned starches may be used. The viscosity of the final product thus may be modified by selection of an appropriate starch, as will be apparent to one of ordinary skill in the art.

### EXAMPLE 12

A product was prepared in accordance to the process as set forth in Example 1, except that 0.300% sodiumtrimetaphosphate (crosslinker) was added prior to the addition of the propylene oxide. Assay and analysis of the finished product showed it to be a water soluble starch having a hydroxypropyl content of 15.46% and an MS of 0.500, the reaction proceeding at a reaction efficiency of 51.5%. This example thus illustrates that a crosslinker may be incorporated in connection with the present invention.

### COMPARATIVE EXAMPLE

This Example illustrates preparation of a crosslinked hydroxypropyl starch by crosslinking a hydroxypropylated starch with phosphorus oxychloride.

To a pressure reactor equipped with an agitator, pressure gauge, a steam source and a thermometer were added 84 g H₂O, 2500 mL EtOH, 110 g 50% NaOH, 1100 g dry basis of an acid-modified starch (B890, available from Grain Processing Corporation, Muscatine, Iowa). After stirring for three minutes, 193 g propylene oxide (17.5% on starch) was added and the reactor was sealed. The reactor contents were heated to about 100° C. and held at about 100° C. for two hours. After the two-hour hold, the product was cooled to 57° C. and 0.139 g POCl₃ was added and held at 55°-57° C. for 10 minutes. After the 10-minute hold, the pH was adjusted to 5.35 with 300 mL acetic acid and 135 mL concentrated HCl. Next, 5.5 g of NaClO₂ was added, followed by a 20-minute hold. The final product, which had a hydroxypropyl substitution of just under 9%, was recovered by filtering, washing with 1L 190 proof EtOH. The filter cake was resuspended in 2L 160 proof EtOH, filtered and washed with 1L 190 proof EtOH. The latter was repeated with a final wash of 2L 190 proof EtOH and dried.

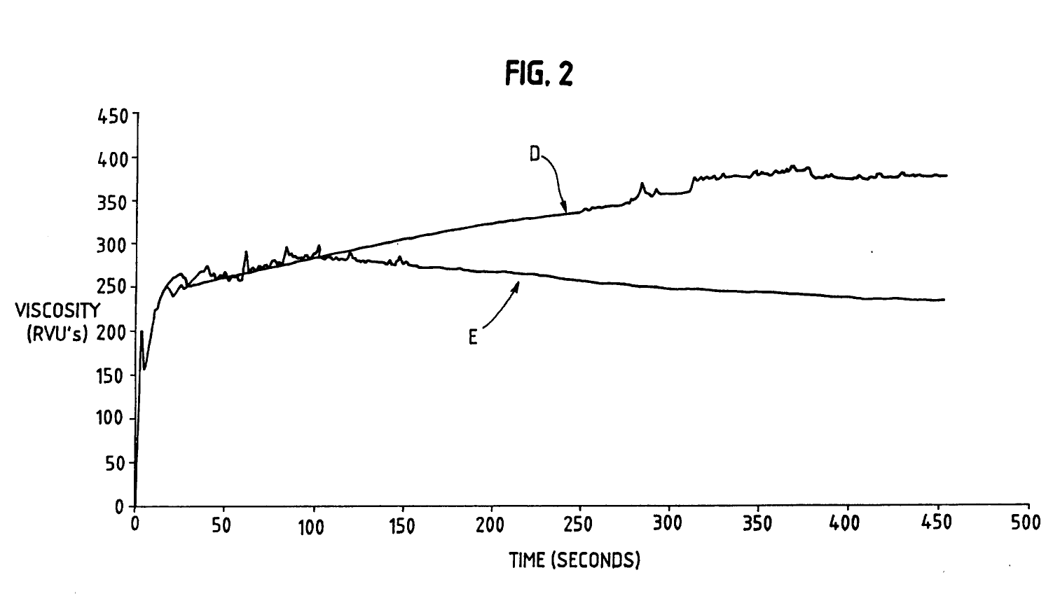

The Example was repeated, except that the crosslinking step was omitted. FIG. 2 shows that the POCl₃ crosslinked product (curve D) generally has a higher viscosity over time than the starch prepared without crosslinking (curve E). Each starch was on the borderline for pasting characteristics.

### EXAMPLE 14

This Example illustrates preparation of a crosslinked hydroxypropyl starch by crosslinking during the hydroxypropylation reaction with epichlorohydrin.

To a pressure reactor equipped with an agitator, pressure gauge, a steam source and a thermometer were added 84 g H₂O, 2500 mL EtOH, 110 g 50% NaOH, 1100 g dry basis of a pearl starch and 0.138 g epichlorohydrin. After stirring three minutes, 275 g propylene oxide (25% on starch) was added and the reactor was sealed. The reactor contents were heated to about 100° C. and held at about 100° C. for two hours. After the two-hour hold, the product was cooled to 57° C. and the pH was adjusted to 5.42 with 300 mL acetic acid and 140 mL concentrated HCl. Next, 4.4 g of NaClO₂ was added, followed by a 20-minute hold. The final product, which had a hydroxypropyl substitution of well over 10%, was recovered by filtering and washed with 1L 190 proof EtOH. The filter cake was resuspended in 2L 160 proof EtOH. The latter was repeated with a final wash of 2L 190 proof EtOH and dried.

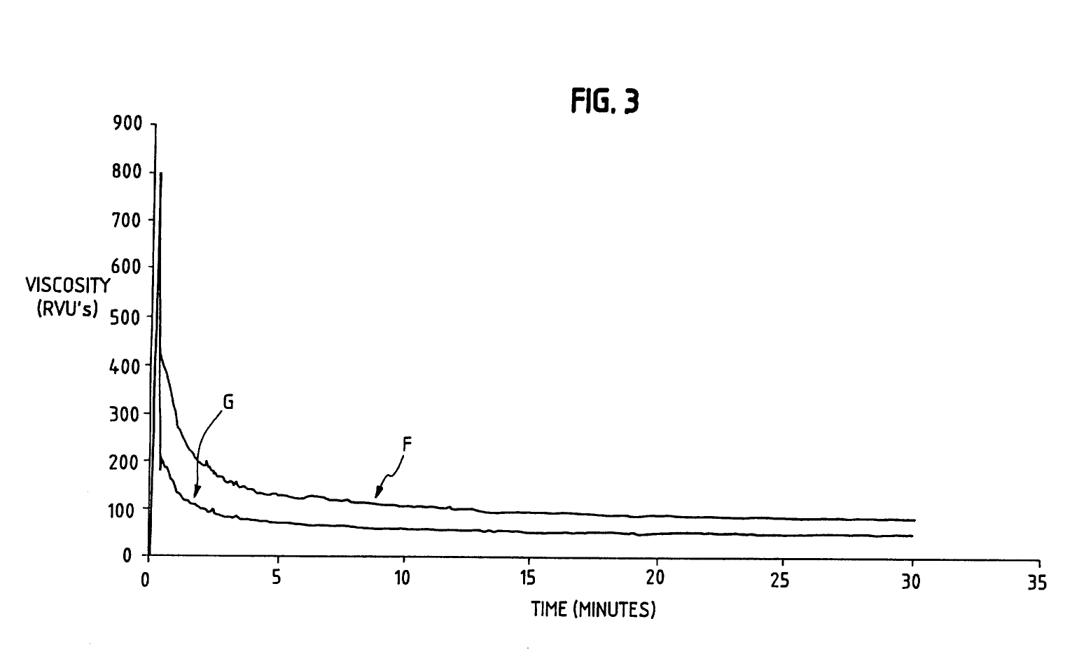

This Example was repeated without epichlorohydrin. FIG. 3 shows that the crosslinked product (curve F) had a higher viscosity than the product obtained without crosslinking (curve G), and yet was cold water soluble.

It is thus seen that the foregoing general objects have been achieved. The invention provides an efficient, economical method for preparing a hydroxyalkyl starch. The hydroxyalkyl starch prepared in accordance with the invention is granular and cold water soluble.

While particular embodiments of the invention have been shown, it will be understood that the invention is not limited thereto since modifications may be made by those skilled in the art, particularly in light of the foregoing teachings. All references cited herein are hereby incorporated by reference in their entireties.

What is claimed is:

1. A method for preparing a hydroxyalkyl starch, comprising the steps of:
providing a starch; and
reacting said starch with a starch hydroxyalkylating agent in the presence of an alcohol and an alkali metal at a temperature effective to produce a granular hydroxyalkylated starch having an MS sufficient to render said hydroxyalkylated starch cold water soluble.

2. A method according to claim 1, wherein the MS of said starch is greater than about 0.30 after hydroxyalkylation.

3. A method according to claim 1, wherein the MS of said starch ranges from about 0.30 to about 0.70 after hydroxyalkylation.

4. A method according to claim 1, wherein the MS of said starch ranges from about 0.4 to 0.50 after hydroxyalkylation.

5. A method according to claim 1, wherein said temperature ranges from about 90° C. to about 110° C.

6. A method according to claim 1, wherein the reaction of starch with the hydroxyalkylating agent occurs for a time period ranging from about 1.5 hours to about 2 hours.

7. A method according to claims 1-3, wherein said hydroxyalkylating agent is propylene oxide or ethylene oxide.

8. A method according to claim 7, wherein said hydroxyalkylating agent is ethylene oxide.

9. The starch prepared in accordance with claim 1.

10. A method for preparing a crosslinked hydroxyalkyl starch, comprising the steps of:
providing a starch;
reacting said starch with a starch hydroxyalkylating agent in the presence of an alcohol and an alkali metal at a temperature effective to produce a granular hydroxyalkylated starch having an MS sufficient to render said hydroxyalkylated starch cold water soluble; and
crosslinking said starch with a poly-functional crosslinking agent.

11. A method according to claim 10, wherein said poly-functional crosslinking agent is selected from among phosphorus oxychloride and epichlorohydrin.

12. A method according to claim 10, wherein the MS of said starch is greater than about 0.30 after hydroxyalkylation.

13. A method according to claim 10, wherein the MS of said starch ranges from about 0.30 to about 0.70 after hydroxyalkylation.

14. A method according to claim 10, wherien the MS of said starch ranges from about 0.4 to 0.50 after hyrdoxyalkylation.

15. A method according to claim 10, wherein said temperature ranges from about 90° C. to about 110° C.

16. A method according to claim 10, wherein the reaction of starch with the hydroxyalkylating agent occurs for a time period ranging from about 1.5 hours to about 2 hours.

17. A method according to claim 10, wherein said hydroxyalkylating agent is propylene oxide or ethylene oxide.

18. A method according to claim 10, wherein said hyroxyalkylating agent is ethylene oxide.

19. The starch prepared in accordance with claim 10.

20. A method for preparing a crosslinked hydroxyalkyl starch, comprising the steps of:
providing a starch; and
reacting said starch with a starch hydroxyalkylating agent in the presence of an alcohol and an alkali metal and a poly-functional crosslinking agent at a temperature effective to produce a granular, crosslinked hydroxyalkylated starch having an MS sufficient to render said hydroxyalkylated starch cold water soluble.

21. A method according to claim 20, wherein said poly-functional crosslinking agent is selected from among phosphorus oxychloride and epichlorohydrin.

22. A method according to claim 20, wherein the MS of said starch is greater than about 0.30 after hydroxyalkylation.

23. A method according to claim 20, wherein the MS of said starch ranges from about 0.30 to about 0.70 after hydroxyalkylation.

24. A method according to claim 20, wherein the MS of said starch ranges from about 0.4 to 0.50 after hydroxyalkylation.

25. A method according to claim 20, wherein said temperature ranges from about 90° C. to about 110° C.

26. A method according to claim 20, wherein the reaction of starch with the hydroxyalkylating agent occurs for a time period ranging from about 1.5 hours to about 2 hours.

27. A method according to claim 20, wherein said hydroxyalkylating agent is propylene oxide or ethylene oxide.

28. A method according to claim 27, wherein said hydroxyalkylating agent is ethylene oxide.

29. The starch prepared in accordance with claim 20.
